(19) United States
(12) Patent Application Publication
(10) Pub. No.: US 2019/0020794 A1
(43) Pub. Date: Jan. 17, 2019

(54) Photographic Stitching Device

(71) Applicant: Christopher Brownfield, Imlay City, MI (US)

(72) Inventor: Christopher Brownfield, Imlay City, MI (US)

(21) Appl. No.: 15/650,892

(22) Filed: Jul. 15, 2017

(51) Int. Cl. H04N 5/225; G03B 17/04; H04N 5/232

(52) U.S. Cl. CPC H04N 5/2253; H04N 5/23238; G03B 17/045

(57) ABSTRACT

Rather than simply integrating with existing equipment by replacement the film holder, this invention is designed to modify existing large format camera equipment substantially by replacing the film holder, film holder receiver, and the traditional full-frame bellows with the apparatus and an external digital sensor.

The apparatus is comprised of a digital sensor mount that slides within an interior frame along one axis, while the interior frame itself slides along an orthogonal axis within an exterior frame. Additionally, instead of a full-frame bellows, a much smaller partial-frame bellows protects the sensor from ambient light while flexing to accommodate the motion of the sensor along both axes.

Overall, this invention provides the following benefits over prior art: 1) it permits a greater range of sensor motion and composite resolution for a given external frame size; 2) it eliminates the need for a light shield from the rear frame; 3) its lack of a protruding light shield permits a wider range of external frame movements described by the Scheimpflug principle; 4) it is simpler to construct, and; 5) it is easier to operate.

### BACKGROUND OF THE INVENTION

Traditional large format cameras and digital sensors were generally not designed to work together; for the most part, they were not even manufactured during the same decades. In recent years, one inventor has attempted to bridge this divide by creating photographic stitching device with limited capability, permitting photographers to construct composite images from multiple digital captures through a fixed large format lens.

### PRIOR ART

The closest preceding invention is an apparatus which permits four-frame and nine-frame stitching of digital images within the film plane (U.S. Pat. No. 8,538,253). That invention integrates with existing large format cameras by replacing the detachable film holder with the apparatus and an external digital sensor. It utilizes the existing full-frame camera bellows and a mask that slides with the sensor's planar movements to block light from the rear frame. The mask protrudes from the outside of the frame when the sensor is shifted to various positions, which limits the overall compositional motion of the camera collectively described by the Scheimpflug principle.

### DESCRIPTION OF THE PREFERRED EMBODIMENTS

1. A rigid exterior frame 1 made of metal such as aluminum, steel, brass, or bronze: 1) attaches to external camera frame 5, and; 2) holds an interior frame 2.
2. A rigid metal interior frame 2 made of machined metal such as aluminum, steel, brass, or bronze: 1) slides along a single translational axis within parallel channels of an exterior frame 1, and; 2) holds an internal mount 7.
3. An internal mount 2 made of machined metal such as aluminum, steel, or brass, or bronze slides along a single translational axis (orthogonal to the axis described above in #2), and provides a mounting surface for: 1) an external detachable digital sensor 6 and; 2) a flexible bellows 3 made of opaque material such as nylon, leather, or cotton.
4. The flexible bellows 3 blocks external light from striking the sensor 6 and attaches to: 1) the internal mount 2, and 2) the lens mount of an external camera 4.
5. The external bellows 3 attaches to the internal mount 7 using magnets, and is guided into place by a protruding alignment guide that mates with a groove on the mount and also serves as a light-tight baffle.
6. The exterior frame 1 and interior frame 2 possess several detents, which allow for easy repositioning of the internal mount 7 at evenly spaced intervals for rapid accurate positioning by hand.
7. The internal mount 7 is comprised of two distinct pieces: 1) a mounting device for mating to external digital imaging sensors 6, and; 2) a detachable plate which mates to the partial frame bellows 3.
8. The apparatus is used in conjunction with a detachable digital imaging sensor 6, an external camera frame 5, and an external lens 4. When these items are assembled, the photographer may compose an image over the virtual image plane coincident with the digital sensor. This composition involves moving the exterior frame throughout six degrees of freedom (3 translational and 3 rotational). Upon completing the composition, the photographer may then capture individual segments of the virtual image plane that are transmitted through partial frame bellows.

### DESCRIPTION OF DRAWINGS

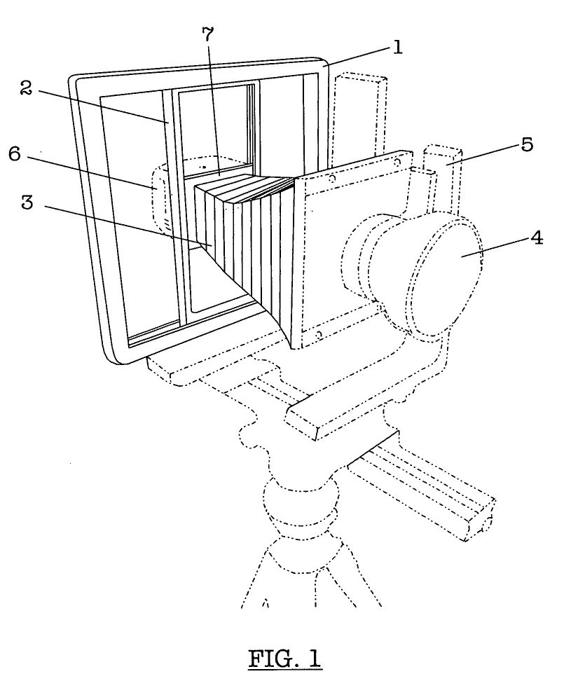

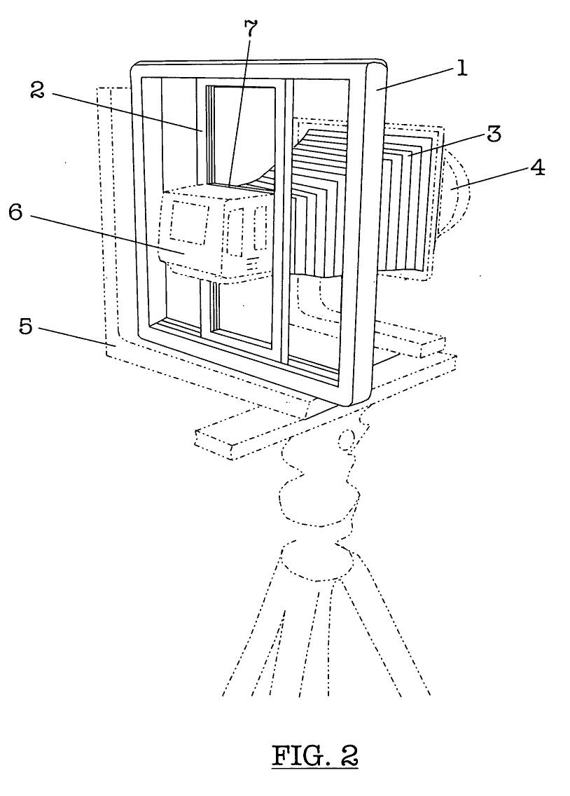

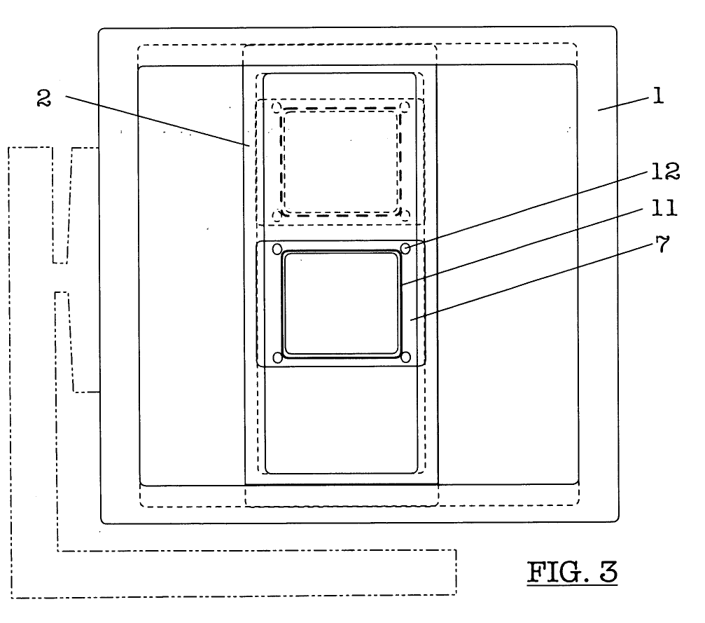

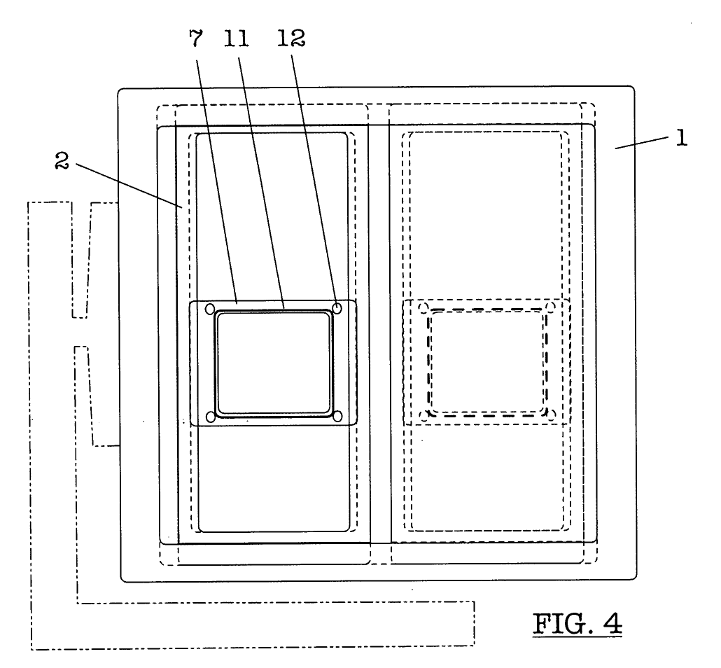

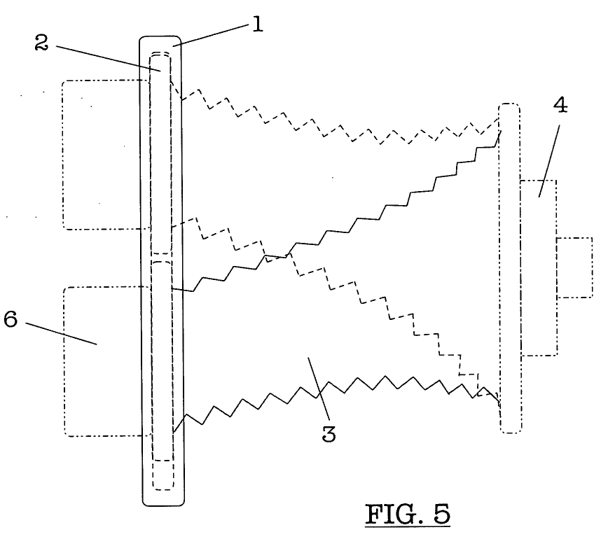

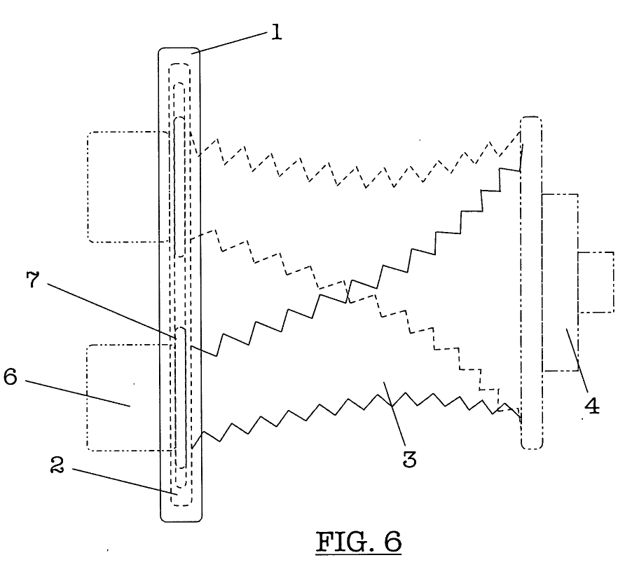

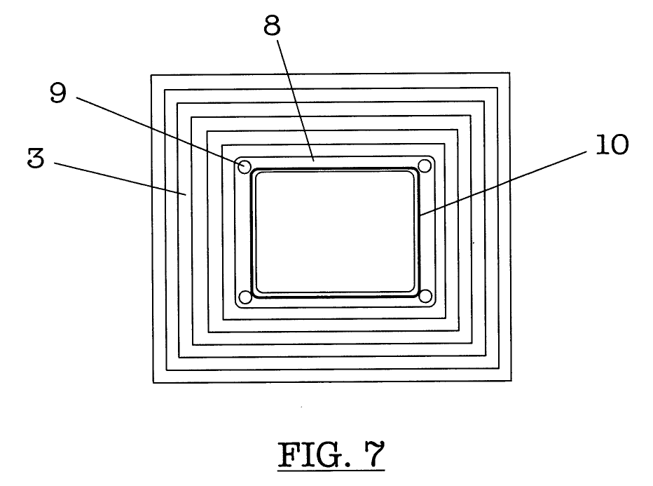

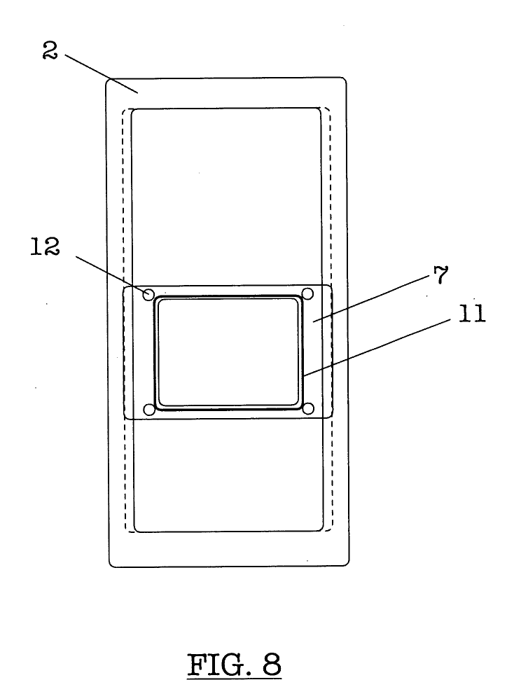

1. FIG. 1 shows the apparatus in perspective from the front. The exterior frame 1 is attached to the camera frame 5.
2. FIG. 2 shows the apparatus in perspective from the rear. In this view, the digital back 6 obscures the sliding internal mount 7.
3. FIG. 3 shows the apparatus from the rear. In this depiction, the exterior frame 1 holds a laterally sliding interior frame 2, which in turn holds a vertically sliding internal mount 7. The interior and exterior frames both have channels cut to allow for the precise linear motion of their internal components along a single axis. The internal mount is shown in two positions, lowered partially and raised partially. The bellows 3 and detachable digital sensor 6 are omitted for clarity.
4. FIG. 4 shows the identical view point of FIG. 3, but depicts the internal sliding frame in two positions, partially left and partially right.
5. FIG. 5 shows the apparatus from the top with bellows 3 and digital sensor 6 attached. The sliding interior frame 2 and partial-frame bellows 3 are depicted in two positions, partially left and right.
6. FIG. 6 shows the apparatus from the side with bellows 3 and digital sensor 6 attached. The sliding internal mount 7 is depicted in two positions, partially raised and partially lowered.
7. FIG. 7 shows the detachable mounting plate 8 and partial frame bellows 3 from the rear. The double-thick line denotes the protruding alignment guide 10. The magnets 9 hold the plate in place on the internal sliding mount 7.
8. FIG. 8 shows the internal sliding mount 7 from the front surface, which mates with the detachable mounting plate 8. The protruding alignment guide of FIG. 7 mates with the groove 11, depicted with a double-thick line. The magnets 12 coincide with the magnets 9 on the detachable mounting plate.

1) A photographic stitching device comprising:
An exterior rectangular frame having a rectangular opening with parallel channels on opposite internal sides;
A nested rectangular interior frame with internal parallel grooves orthogonal to said channels of said exterior frame. Said interior frame fits within and slides along said channels of said exterior frame;
A rectangular mount for attaching a sensor on one side and a bellows on the other side. Said mount fits within and slides along the internal grooves of said internal frame;
A flexible light-tight bellows that attaches to said mount at one end and the lens standard of an external camera on the other end.

2) The photographic stitching device of 1), further comprising a mounting structure attached to said exterior frame for receiving a camera frame.

3) The photographic stitching device of 1), further comprising a large format camera frame.

4) The photographic stitching device of 1), further comprising an external frame with internal parallel channels that contain detents for rapid, precise positioning of said interior frame.

5) The photographic stitching device of 1), further comprising an interior frame with internal parallel grooves that contain detents for rapid, precise positioning of said mount.

6) The photographic stitching device of 1), further comprising a magnetic plate on said bellows for rapidly attaching said bellows to said mount.

7) The photographic stitching device of 1), further comprising magnetic mounting plate for attaching a ground glass to the exterior frame

8) The photographic stitching device of 1), further comprising magnetic mounting plate for attaching a full-frame bellows to the external frame.
